(19) United States
(12) Patent Application Publication
(10) Pub. No.: US 2003/0163578 A1
(43) Pub. Date: Aug. 28, 2003

(54) Adaptive snoop utility

(76) Inventor: Jici Gao, San Jose, CA (US)

Correspondence Address: PARK, VAUGHAN & FLEMING LLP, 702 MARSHALL STREET, SUITE 310, REDWOOD CITY, CA, 94063, US

(21) Appl. No.: 10/068,598

(22) Filed: Feb. 6, 2002

(51) Int. Cl. G06F 15/16

(52) U.S. Cl. 709/230; 709/250

(57) ABSTRACT

A system and method for a data link user (e.g., snoop utility) to adapt to a protocol processed by a data link provider (e.g., device driver). In a system in which a data link user connects with a data link provider through DLPI (Data Link Provider Interface), the provider is capable of passing to the user a detailed description of a communication protocol handled by the provider. The provider may be requested to send the data if a protocol or media type supported by the provider is of an unknown or “other” type. The provider may describe the protocol using XML or a detailed set of data portraying the protocol or communication structure. Alternatively, the data link provider may send the data link user a Java applet or other executable module, or enable the user to invoke a function embedded within the provider.

### BACKGROUND

This invention relates to the fields of computer systems and data communications. More particularly, a system and methods are provided for adapting a snoop utility or other data link user for a communication protocol handled by a device driver (e.g., for a communication interface) or other data link service provider.

Traffic analysis tools, such as snoop utilities, are very helpful for designing or developing a network, troubleshooting, analyzing communication traffic, etc. However, a snoop utility must be designed and coded with knowledge of the protocols that will be implemented on the network.

For example, a snoop utility for a UNIX™ platform may be based on DLPI (Data Link Provider Interface) Version 2, the technical standard administered by The Open Group that defines an interface to services of the data link layer of the OSI reference model. More specifically, DLPI provides a STREAMS kernel-level instantiation of the Data Link Service Definition ISO/IEC 8886 and Logical Link Control ISO/IEC 8802-2 (LLC). The DLPI interface supports many communication protocols (e.g., Ethernet, Token Ring, Fiber Channel, FDDI), and facilitates the use of a variety of conforming data link service providers.

Using DLPI, a data link user—such as a snoop utility or other user-level application—may draw upon the services of a data link provider—such as a device driver for a network interface circuit—through the exchange of appropriate primitives. For example, the data link user may query the data link provider in an attempt to determine a type of medium the provider supports. The provider may respond with an indication of a medium type, in response to which the snoop utility may then tailor its mode of operation accordingly.

Unfortunately, with DLPI a data link provider can only answer a standard request for identification of its supported medium with one of a predetermined set of responses (e.g., known media types). If its medium type is not included in that set (e.g., because it is a new type not yet incorporated into the types known by DLPI), the provider must respond with a default answer indicating some “other” type. This prevents the snoop utility from being able to analyze the traffic received by the provider until the DLPI standard is updated to include the provider's media type and/or the snoop utility is supplemented with a function or procedure for that medium. Because it can take a significant period of time to add a new medium type to DLPI, the snoop utility may remain unable to support traffic received by the data link provider for some time.

### SUMMARY

In one embodiment of the invention, a system and methods are provided for adaptively determining a data link provider's media type or medium access control type. In this embodiment, the provider may respond to a data link user's inquiry by describing a communication protocol that the provider is configured to handle. The description allows the user to adapt itself accordingly, and process communications that it otherwise could not.

In an embodiment of the invention, a data link user (e.g., a snoop utility) issues a request for information to a data link provider (e.g., a device driver). Illustratively, the request may comprise the DLPI primitive DL_INFO_REQ. Because the medium access control type supported by the data link provider is unknown to (e.g., not yet registered with) DLPI, the provider responds with the primitive DL_INFO_ACK with a medium access control type parameter (dl_mac_type) having the value DL_OTHER.

To learn, or adapt itself for, a communication to be processed by the data link provider, the data link user then requests the provider to identify a communication protocol that it will handle for that media type. The data link provider responds with information describing the communication protocol or otherwise facilitating parsing of the protocol. For example, the data link provider may give the data link user a Java applet or other executable module for parsing the protocol, or enable the user to invoke a parsing function on the provider. Or, the provider may send the user an XML (Extensible Markup Language) document or a detailed set of data describing the protocol format. Illustratively, the DLPI interface may be extended to include a system call or function supporting this request/response.

### DESCRIPTION OF THE FIGURES

FIG. 1 is a block diagram depicting a request/response between a data link user and a data link provider for identifying a type of medium access control supported by the provider.

FIG. 2 depicts a data link user and a data link provider communicating to inform the user of a medium access control type supported by the provider, in accordance with an embodiment of the present invention.

FIG. 3 illustrates a sequence of exchanges between a data link user and a data link provider to identify a communication protocol supported by the provider, in accordance with an embodiment of the present invention.

### DETAILED DESCRIPTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

The program environment in which a present embodiment of the invention is executed illustratively incorporates a general-purpose computer or a special purpose computing device. Details of such devices (e.g., processor, memory, data storage, display) may be omitted for the sake of clarity.

It should also be understood that the techniques of the present invention may be implemented using a variety of technologies. For example, the methods described herein may be implemented in software executing on a computer system, or implemented in hardware utilizing either a combination of microprocessors or other specially designed application specific integrated circuits, programmable logic devices, or various combinations thereof. In particular, the methods described herein may be implemented by a series of computer-executable instructions residing on a suitable computer-readable medium. Suitable computer-readable media may include volatile (e.g., RAM) and/or non-volatile (e.g., ROM, disk) memory, carrier waves and transmission media (e.g., copper wire, coaxial cable, fiber optic media). Exemplary carrier waves may take the form of electrical, electromagnetic or optical signals conveying digital data streams along a local network, a publicly accessible network such as the Internet or some other communication link.

In one embodiment of the invention, a system and method are provided for enabling a data link user to adaptively learn the format of communications processed by a data link provider. More particularly, the data link provider is configured to describe to the data link user the format of packets, frames, cells or other communications that it processes. Subsequently, the data link user may use that description to parse, analyze or otherwise handle those communications. Or, the data link provider may offer executable code, or access to such code, for parsing the communications.

In one implementation of this embodiment, the data link provider comprises a device driver for a network interface circuit or other communication interface. The data link user comprises a snoop utility for parsing or analyzing communication traffic. In other embodiments and implementations of the invention, the system and methods described herein may be applied for other types of data link providers and/or users.

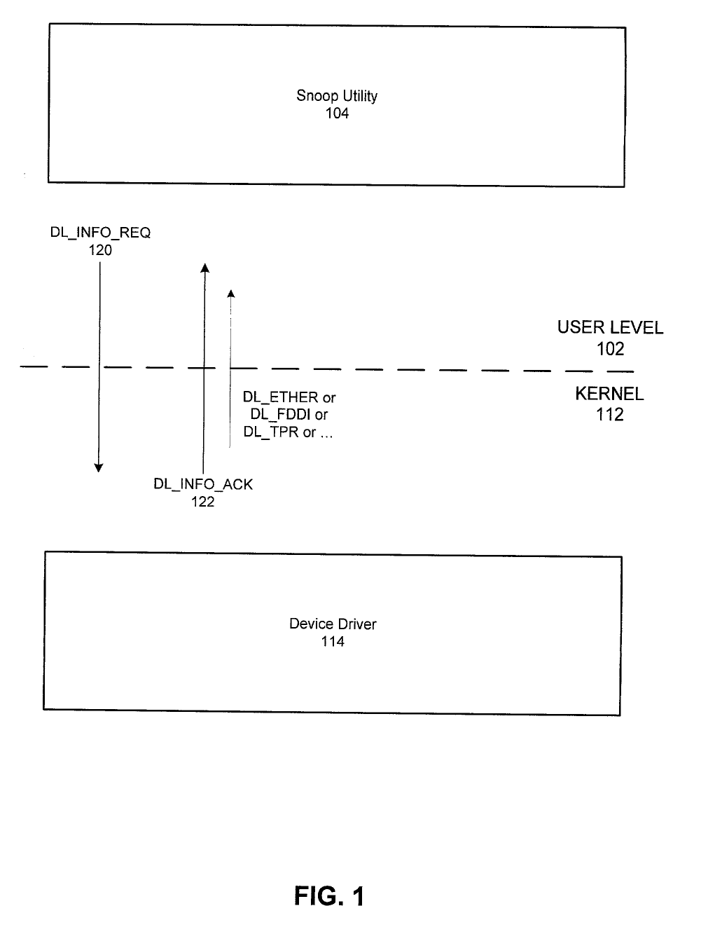

FIG. 1 demonstrates one manner in which a data link user may determine a data link provider's media type, in particular, the MAC (Medium Access Control) type for the provider's media type. In FIG. 1, a data link user such as snoop utility 104 operates in user level 102 of a host operating system (e.g., the Solaris™ operating system by Sun Microsystems, Inc.). A data link provider such as device driver 114 operates in kernel 112 of the operating system.

In the system of FIG. 1, snoop utility 104 needs to identify the MAC or media type(s) supported by device driver 114 to determine how to parse communication received by the device driver, and therefore issues primitive DL_INFO_REQ 120 using DLPI (Data Link Provider Interface). In response to this request, device driver 114 returns DL_INFO_ACK 114, which includes the data field or parameter dl_mac_type identifying a media type supported by the device driver (e.g. DL_ETHER for Ethernet, DL_FDDI for Fiber Distributed Data Interface, DL_TPR for Token Passing Ring). If the media type supported by device driver 114 is not one of the standard types registered with DLPI, the device driver may set dl_mactype to DL_OTHER, to indicate that DLPI does not include a predefined value for its supported type of medium access control.

If the media type identified to snoop utility 104 by device driver 114 corresponds to a DLPI-registered type (e.g., Ethernet, FDDI, Token Ring), then the utility may operate accordingly by parsing or analyzing the communication traffic received through the device driver in accordance with the specified type. Thus, if the device driver identified its media type as Ethernet, the snoop utility may then configure itself to apply the known format of Ethernet packets to parse packets received by the device driver.

If, however, device driver 114 identified its media type as DL_OTHER, indicating that DLPI does not recognize the device driver's media type, then snoop utility 104 will not know the form or format of communications received by the device driver.

Illustratively, the response codes that a data link provider may use when responding to DL_INFO_REQ may be stored in the header file <sys/dlpi.h>, and are taken from the specification for DLPI, which is revised every few years. Thus, as new types of networks or data links are introduced, a significant period of time may pass before a MAC type is assigned and reflected in the specification. In the meantime, utilities such as snoop, ARP (Address Resolution Protocol), etc., are unable to readily determine the device driver's media type, and therefore cannot parse or analyze communications processed by the driver.

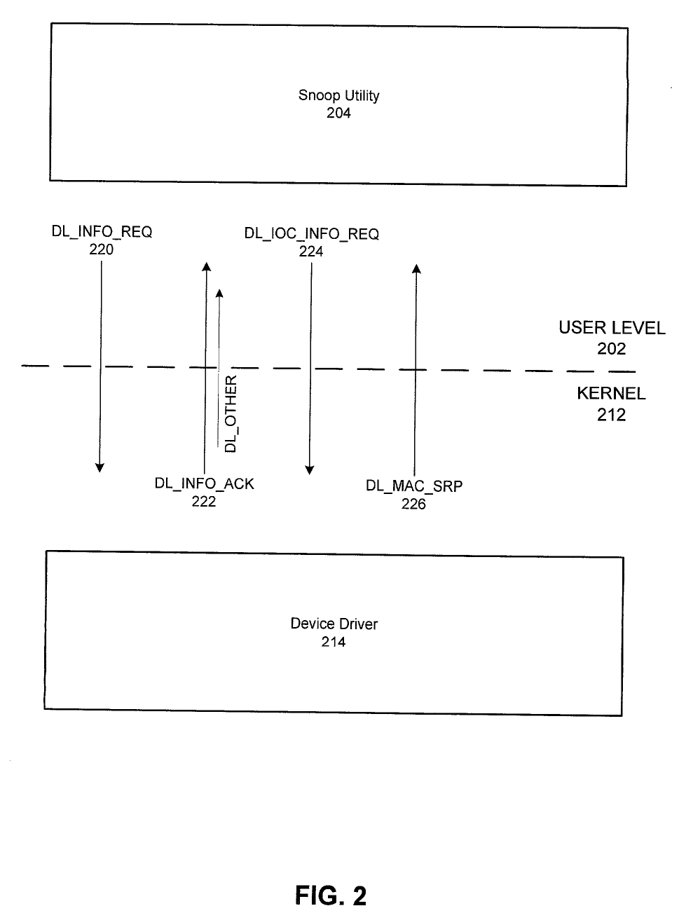

FIG. 2 demonstrates an interchange between a data link user (snoop utility 204) and a data link provider (device driver 214) to identify a MAC or media type supported by the provider, according to one embodiment of the invention. In this embodiment, device driver 214 responds to DL_INFO_REQ 220 from snoop utility 204 with DL_OTHER (i.e., as part of DL_INFO_ACK 222). This indicates that DLPI does not yet recognize the driver's media type.

Therefore, in order to learn the media type supported by device driver 214, or the protocol that will be handled by the driver, snoop utility 204 issues a special ioctl call, or function, DL_IOC_INFO_REQ 224. In this embodiment of the invention, DLPI is extended to use DL_IOC_INFO_REQ to provide an alternative namespace for MAC types, which can be augmented as necessary by different suppliers of data link providers.

Illustratively, device driver 214 responds to DL_IOC_INFO_REQ 224 by identifying a MAC type other than those known to DLPI. DL_MAC_SRP 226, for example, identifies the device driver MAC type as SRP (Spatial Reuse Protocol). In an alternative embodiment, MAC types reported as DL_MAC_SRP may include a type known to DLPI.

In the embodiment of FIG. 2, the DL_IOC_INFO_REQ request/response may include additional information regarding other features supported by the device driver. To support this ioctl call, the DLPI header file (e.g., <sys/DLPI.h>) may be supplemented with a declaration or definition similar to the following:

#define DL_IOC_INFO_REQ (DLIOC|11)
typedef struct {

| | |
|---|---|
| t_uscalar_t | dl_mac_type; |
| u_int32_t | dl_feature_flags; |
| u_int32_t | reserved[14]; |

| } dl_ioc_info_ack_t | |
|---|---|
| #define DL_MAC_SRP | 0xFF000001 |

In this example, DL_MAC_SRP comprises an extension to standard DLPI media types. The value 0xFF000001 distinguishes this supplemental media type from types registered with DLPI. In the illustrated embodiment of the invention, device driver 214 may be configured to respond to DL_IOC_INFO_REQ with one of the predefined DLPI codes (e.g., DL_ETHER, DL_FDDI). This may allow the snoop utility to issue DL_IOC_INFO_REQ 224 without first issuing, or waiting for a result from, DL_INFO_REQ 220.

Assuming that snoop utility 204 is configured to recognize the device driver's media type (e.g., SRP), it may then configure itself as necessary to handle the driver's communications.

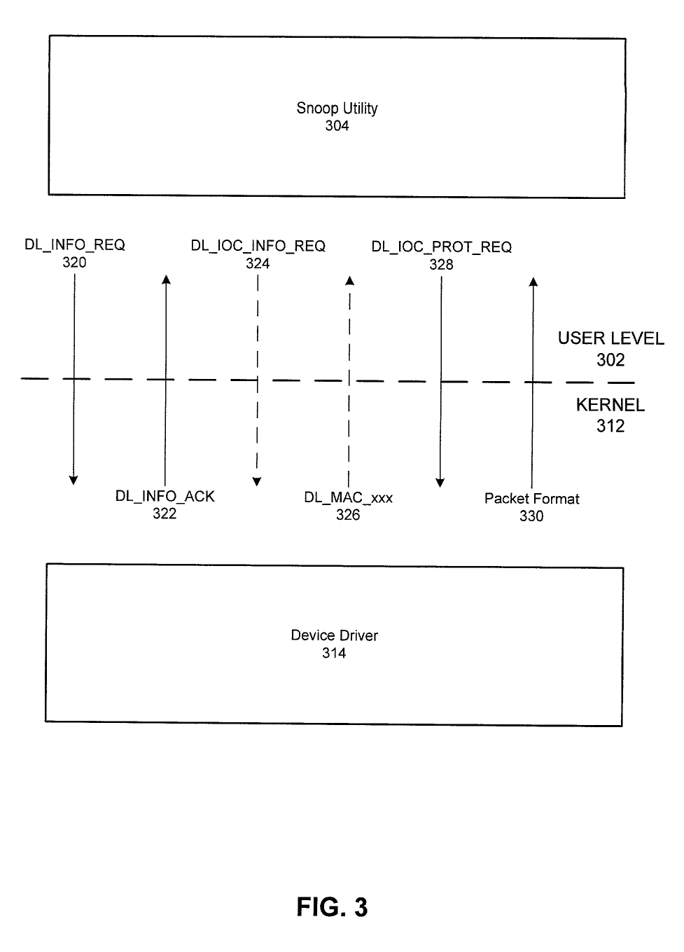

FIG. 3 demonstrates an embodiment of the invention in which a data link provider may explicitly describe the format of, or offer means for parsing, a protocol the provider is configured to handle.

In the embodiment of FIG. 3, snoop utility 304 may first issue the primitives DL_INFO REQ 320 and/or DL_IOC_INFO_REQ 324. If either of these are sent, device driver 314 may respond with DL_INFO_ACK 322, which may report a media type of DL_OTHER, and/or DL_MAC_xxx 326 (wherein xxx identifies the driver's MAC type).

However, these exchanges are insufficient, in this embodiment of the invention, for the snoop utility to configure itself to parse or analyze the driver's traffic. In particular, if DL_IOC_INFO_REQ 324 is not issued, then the only information regarding the driver's media type received from the driver is the parameter DL_OTHER received with DL_INFO_ACK 322 in response to DL_INFO_REQ 320. Otherwise, if DL_IOC_INFO_REQ 324 was issued, the device driver responded with a MAC type (i.e., xxx in FIG. 3) that is unknown to the snoop utility.

Therefore, in the illustrated embodiment, snoop utility 304 issues another ioctl call or function, DL_IOC_PROT_REQ 328. This is interpreted by device driver 314 as a request to describe, in detail, the format of the protocol(s) that the driver is configured to handle. Device driver 314 will then respond with packet or protocol format 330, or means for parsing the packet or protocol. Although identified here as a packet format, in other embodiments, the format provided by a device driver may correspond to a frame, cell or other communication structure.

One skilled in the art will appreciate that by using the method described in conjunction with FIG. 3, a snoop (or other) utility may be educated as to the structure of communications that it would otherwise not be able to handle. When a new device driver is implemented, or a device driver supporting a new or altered MAC or media type is employed, a snoop utility may reconfigure itself accordingly, without having to be replaced, patched or updated.

Illustratively, snoop utility 304 only needs to retrieve and learn the new protocol (packet format) when the utility is launched on the host computer. The configuration information it receives is then retained as long as necessary or possible.

In different embodiments of the invention, a data link provider may identify a protocol or communication structure to a data link user in different ways. For example, the structure could be transferred via XML (extensible Markup Language), could be exported as a function, could be supplied as a Java™ applet, as a table or other set of data, etc.

Thus, in one embodiment of the invention, XML is used to describe the data link provider's protocol(s), including the architecture of each protocol as related to others. More particularly, in response to the primitive DL_IOC_PROT_REQ, the data link provider sends an XML DTD (Document Type Definition) to the requesting data link user, with an XML document containing the protocol details. The user then processes the document to understand the new protocol.

In another embodiment of the invention, a function designed to parse a packet or other communication is embedded in the data link provider. The data link user is configured to invoke that function when needed.

In yet another embodiment of the invention, a data link provider is enhanced with an exportable Java applet or other program module. In response to the DL_IOC_PROT_REQ primitive, the data link provider passes the applet or module to the data link user, which executes it as necessary to process traffic handled by the provider.

In one particular embodiment of the invention, a data link provider is configured to provide a detailed set of data describing the format or structure of one or more protocols that it supports. The data are returned to a data link user in response to the primitive DL_IOC_PROT REQ or, in an alternative embodiment of the invention, may be returned in response to DL_INFO REQ or DL_IOC_INFO_REQ.

In this embodiment, the data are transmitted in a data structure understood by both the data link provider and data link user. Illustratively, the data structure may be defined in <sys/dlpi.h>, possibly in a section containing DLPI extensions for a particular supplier or manufacturer of the provider.

In one implementation of this embodiment, the data structure may be similar to the following:

#define DL_IOC_PROT_REQ (DLIOC|12)
typedef struct {

| t_uscalar_t | dl_prot_type; |
|---|---|
| uint32_t | dl_prot_flags; |
| struct protocol_seq dl_prot_field; | |
| uint32_t | reserved[4]; |

} dl_ioc_prot_ack_t
struct protocol_seq {

| | | |
|---|---|---|
| int | num_of_prot; | /* # of protocols in packet */ |
| char | prot_offset[8]; | /* offset to each protocol */ |
| struct | protocol prot[]; | /* the protocols */ |

}
struct protocol {

| | | |
|---|---|---|
| int | total_entries; | /* # of prot_field[]entries */ |
| int | num_of_field; | /* # of fields in protocol */ |
| int | protocol_type; | /* protocol type */ |
| char | protocol_name[8]; | /* protocol name */ |
| int | header_size; | /* protocol header size */ |
| struct | protocol_field prot_field[]; | /* protocol field */ |

}
struct protocol_field {

| | | |
|---|---|---|
| char | id; | /* field id */ |
| char | type; | /* field type */ |
| short | size; | /* field size */ |
| int | vtype; | /* field value type */ |
| int | value; | /* field value */ |
| int | length; | /* leaf data length */ |
| int | format; | /* how to print leaf data */ |
| char | label[16]; | /* field label */ |

}

In response to the appropriate request (e.g., DL_IOC_PROT_REQ), the data link provider is obliged to return a response containing the data structure populated with descriptions of its protocols. The requesting data link user then applies the definitions to parse, analyze or otherwise process packets exhibiting the protocols.

The various types of protocol field value types reported by a provider may be interpreted as follows:

enum VTYPE {

| | |
|---|---|
| FIXVALUE, | /* a fixed value */ |
| POSVALUE, | /* a positive value */ |
| VALUE, | /* any value */ |
| BITVALUE, | /* a bit pattern requiring a mask */ |
| PROTOCOL, | /* a protocol */ |
| BPROTCOL, | /* a protocol in bits */ |
| CODE, | /* code */ |
| DCODE, | /* data code, length and data to follow */ |
| MACADDR, | /* MAC address */ |
| LENGTH | /* length value */ |

}

enum TYPE {
CHAR = 1,
SHORT,
INT,
MAC_ADDR,
BITCHAR,
BITSHORT,
BITINT,
NOACTION

}

Example applications for describing a communication protocol to a data link user follow. Example 1 demonstrates illustrative data structures (e.g., the protocol and protocol_field structs described above) for PPP/LCP (Point-to-Point/Link Control Protocol). Example 2 relates to SRP (Spatial Reuse Protocol).

### EXAMPLE 1

(PPP)

{ 6, 3, PPP, “PPP”, 4,

| | | |
|---|---|---|
| { 1, CHAR, 1, FIXVALUE, | 0xFF, | 0, 0, “ALLSTATION” }, |
| { 2, CHAR, 1, FIXVALUE, | 0x03, | 0, 0, “CONTROL” , |
| { 3, SHORT, 2, ETHERTYPE_IP, | PPP_IP, | 0, 0, “PPP_IP” }, |
| { 3, SHORT, 2, ETHERTYPE_IPV6, | PPP_IPV6, | 0, 0, “PPP_IPV6” }, |
| { 3, SHORT, 2, PROTOCOL, | PPP_LCP, | 0, 0, “LCP” }, |
| { 3, SHORT, 2, PROTOCOL, | PPP_IPCP, | 0, 0, “IPCP” } |

}

(LCP)

{ 23, 5, LCP, “LCP”, 4,

| | | |
|---|---|---|
| { 1, CHAR, 1, CODE, | 1, 0, 0, | “CONFIG_REQ” }, |
| { 1, CHAR, 1, CODE, | 2, 0, 0, | “CONFIG_ACK” }, |
| { 1, CHAR, 1, CODE, | 3, 0, 0, | “CONFIG_NAK” }, |
| { 1, CHAR, 1, CODE, | 4, 0, 0, | “CONFIG_REJ” }, |
| { 1, CHAR, 1, CODE, | 5, 0, 0, | “TERMIN_REQ” }, |
| { 1, CHAR, 1, CODE, | 6, 0, 0, | “TERMIN_ACK” }, |
| { 1, CHAR, 1, CODE, | 7, 0, 0, | “CODE_REJ” }, |
| { 1, CHAR, 1, CODE, | 8, 0, 0, | “PROTOCOL_REJ” }, |
| { 1, CHAR, 1, CODE, | 9, 0, 0, | “ECHO_REQ” }, |
| { 1, CHAR, 1, CODE, | 10, 0, 0, | “ECHO_REPLY” }, |
| { 1, CHAR, 1, CODE, | 11, 0, 0, | “DISCARD_REQ” }, |
| { 1, CHAR, 1, CODE, | 12, 0, 0, | “RESERVED” }, |
| { 2, CHAR, 1, POSVALUE, | 0, 0, 0, | “ID” }, |
| { 3, SHORT, 2, LENGTH, | 0, 0, 0, | “Length” }, |
| { 4, CHAR, 1, DCODE, | 1, SHORT, NT, | “MRU” }, |
| { 4, CHAR, 1, DCODE, | 2, NT, HEX, | “ACCM” }, |
| { 4, CHAR, 1, DCODE, | 3, 0, HEX, | “AUTH” } |
| { 4, CHAR, 1, DCODE, | 4, 0, HEX, | “QUALITY-PROT” } |
| { 4, CHAR, 1, DCODE, | 5, NT, NT, | “MAGIC-NUMBER” }, |
| { 4, CHAR, 1, DCODE, | 6, 0, 0, | “Reserved” }, |
| { 4, CHAR, 1, DCODE, | 7, 0, 0, | “Protocol-Compr” } |
| { 4, CHAR, 1, DCODE, | 8, 0, 0, | “ACFCompression” } |
| { 5, CHAR, 1, LENGTH, | 0, 0, 0, | “Length” } |
| } | | |

In Example 1, the snoop utility should already know how to process ETHERTYPE_IP and ETHERTYPE_IPV6, and therefore may simply invoke the appropriate routines for the corresponding portions of a packet.

### EXAMPLE 2

(SRP)

{ 9, 2, SRP, “SRP”, 2,

| | | | |
|---|---|---|---|
| { 1, CHAR, 1, POSVALUE, | 0, | 0, 0, | “TTL” }, |
| { 2, CHAR, 1, BITVALUE, | 0x80, | 0, 0, | “RING-IND” }, |
| { 2, CHAR, 1, BITVALUE, | 0x70, | 0, 7, | “Priority” }, |
| { 2, CHAR, 1, BPROTOCOL, | 0x0e, | 0x011, 0, | “Mode-ATM Cell” }, |
| { 2. CHAR, 1, BPROTOCOL, | 0x0e, | 0x100, 0, | “Mode-CtrlMsg” }, |
| { 2, CHAR, 1, BPROTOCOL, | 0x0e, | 0x101, 0, | “Mode-CtrlMsg” }, |
| { 2, CHAR, 1, BPROTOCOL, | 0x0e, | 0x110, 0, | “Mode-UsageMsg” }, |
| { 2, CHAR, 1, BPROTOCOL, | 0x0e, | 0x111, 0, | “Mode-PacketData” }, |
| { 2, CHAR, 1, BITVALUE, | 0x01, | 0, 0, | “Parity” }, |

}
{ 1, 1, 0x011, “Mode-ATM Cell”, 1,

| | | | | |
|---|---|---|---|---|
| { 1, NOACTION, | 0, POSVALUE, | 0, | 0, 0, | “Not Supported!” }, |

}
{ 7, 7, 0x100, “Mode-CtrlMsg”, 20,

| | | | | |
|---|---|---|---|---|
| { 1, MAC_ADDR, | 6, MACADDR, | 0, | 0, 0, | “Dest-Addr” }, |
| { 2, MAC_ADDR, | 6, MACADDR, | 0, | 0, 0, | “Source-Addr” }, |
| { 3, SHORT, | 2, FIXVALUE, | 0x2007, | 0, 0, | “SRP-Control” }, |
| { 4, CHAR, | 1, VALUE, | 0, | 0, INT, | “Ctrl-Version” }, |
| { 5, CHAR, | 1, CODE, | 1, | 0, INT, | “Topology-Disc” }, |
| { 6, SHORT, | 2, VALUE, | 0, | 0, HEX, | “Ctrl-Checksum” }, |
| { 7, SHORT, | 2, VALUE, | 0, | 0, HEX, | “Ctrl-TTL” }, |

}
{ 7, 7, 0x101, “Mode-CtrlMsg”, 20,

| | | | | |
|---|---|---|---|---|
| { 1, MAC_ADDR, | 6, MACADDR, | 0, | 0, 0, | “Dest-Addr” }, |
| { 2, MAC_ADDR, | 6, MACADDR, | 0, | 0, 0, | “Source-Addr” }, |
| { 3, SHORT, | 2, FIXVALUE, | 0x2007, | 0, 0, | “SRP-Control” }, |
| { 4, CHAR, | 1, VALUE, | 0, | 0, NT, | “CtrL-Version” }, |
| { 5, CHAR, | 1, CODE, | 2, | 0, NT, | “IPS-Mesg” }, |
| { 6, SHORT, | 2, VALUE, | 0, | 0, HEX, | “Ctrl-Checksum” }, |
| { 7, SHORT, | 2, VALUE, | 0, | 0, HEX, | “Ctrl-TTL” }, |

}
{ 3, 3, 0x110, “Mode-UsageMsg”, 10,

| | | | | |
|---|---|---|---|---|
| { 1, MAC_ADDR, | 6, MACADDR, | 0, | 0, 0, | “Orig-Addr” }, |
| { 2, SHORT, | 2, VALUE, | 0, | 0, 0, | “Reserved” }, |
| { 3, SHORT, | 2, VALUE, | 0, | 0, 0, | “Usage” }, |

}
{ 4, 3, 0x111, “Mode-PacketData”, 14,

| | | | | |
|---|---|---|---|---|
| { 1, MAC_ADDR, | 6, MACADDR, | 0, | 0, 0, | “Dest-Addr” }, |
| { 2, MAC_ADDR, | 6, MACADDR, | 0, | 0, 0, | “Source-Addr” }, |

{ 3, SHORT, 2, ETHERTYPE_IP, ETHERTYPE_IP, 0,0, “IPV4” },
{ 3, SHORT, 2, ETHERTYPE_ARP, ETHERTYPE_ARP, 0,0, “ARP” },

}

The foregoing descriptions of embodiments of the invention have been presented for purposes of illustration and description only. They are not intended to be exhaustive or to limit the invention to the forms disclosed. In particular, the primitive and parameters described above are only suggestive. Accordingly, the above disclosure is not intended to limit the invention; the scope of the invention is defined by the appended claims.

Solaris and Java are registered trademarks of Sun Microsystems, Inc., in the United States and other countries.

What Is claimed Is:

1. A method of adapting a data link user for a communication protocol, comprising:
at a data link provider, receiving from a data link user through an interface defined between the data link provider and the data link user, a first request to identify a medium access control type supported by the data link provider;
receiving at the data link provider a second request to identify a communication protocol supported by the data link provider; and
in response to said second request, enabling the data link user to parse the communication protocol.

2. The method of claim 1, further comprising:
in response to said first request, indicating to the data link user that said communication protocol is a protocol not registered with the interface.

3. The method of claim 1, wherein said enabling comprises:
sending the data link user an XML (Extensible Markup Language) document describing said format.

4. The method of claim 1, wherein said enabling comprises:
sending the data link user a set of data describing said format.

5. The method of claim 1, wherein said enabling comprises:
making available to the data link user a set of processor executable instructions for parsing said format.

6. A computer readable storage medium storing instructions that, when executed by a computer, cause the computer to perform a method of adapting a data link user for a communication protocol, the method comprising:
at a data link provider, receiving from a data link user through an interface defined between the data link provider and the data link user, a first request to identify a medium access control type supported by the data link provider;
receiving at the data link provider a second request to identify a communication protocol supported by the data link provider; and
in response to said second request, enabling the data link user to parse the communication protocol.

7. A method of adapting to a communication protocol supported by a data link provider, comprising:
at a data link user, through an interface defined between the data link user and a data link provider, requesting the data link provider to identify a medium access control type supported by the data link provider;
at the data link user, requesting the data link provider to identify a communication protocol supported by the data link provider; and
receiving a description of the format of the communication protocol from the data link provider.

8. The method of claim 7, further comprising:
receiving at the data link user, in response to said request to identify a medium access control type, an indication that said medium access control type is not one of a predetermined set of medium access control types registered with the interface.

9. The method of claim 7, wherein said receiving comprises:
receiving an XML (Extensible Markup Language) document describing said format.

10. The method of claim 7, wherein said receiving comprises:
receiving a set of data describing said format.

11. The method of claim 7, wherein said receiving comprises:
receiving access to a set of processor executable instructions for parsing said communication protocol.

12. A computer readable storage medium storing instructions that, when executed by a computer, cause the computer to perform a method of adapting to a communication protocol supported by a data link provider, the method comprising:
at a data link user, through an interface defined between the data link user and a data link provider, requesting the data link provider to identify a medium access control type supported by the data link provider;
at the data link user, requesting the data link provider to identify a communication protocol supported by the data link provider; and
receiving a description of the format of the communication protocol from the data link provider.

13. A method of adapting a data link user for a communication protocol supported by a data link provider, wherein the data link user and data link provider communicate via an interface, comprising:
at the data link user, issuing a first request to the data link provider to identify a medium access control type supported by the data link provider;
at the data link provider, sending to the data link user a first response comprising an indication that the medium access control type is unknown to the interface;
at the data link user, issuing a second request to the data link provider to identify a communication protocol supported by the data link provider for the medium access control type; and
at the data link provider, sending to the data link user a second response enabling the data link user to parse the communication protocol.

14. The method of claim 13, wherein:
said first request comprises the DLPI (Data Link Provider Interface) primitive DL_INFO_REQ; and
said first response comprises the DLPI primitive DL_INFO_ACK with the parameter dl_mac_type having the value DL_OTHER.

15. The method of claim 13, wherein said second response comprises an XML (Extensible Markup Language) document describing a format of the communication protocol.

16. The method of claim 13, wherein said second response comprises a set of data describing a format of the communication protocol.

17. The method of claim 13, wherein said second response comprises a set of processor executable instructions for parsing the communication protocol.

18. The method of claim 13, wherein said second response comprises access to a set of processor executable instructions, on the data link provider, for parsing the communication protocol.

19. A computer readable storage medium storing instructions that, when executed by a computer, cause the computer to perform a method of adapting a data link user for a communication protocol supported by a data link provider, wherein the data link user and data link provider communicate via an interface, the method comprising:
at the data link user, issuing a first request to the data link provider to identify a medium access control type supported by the data link provider;
at the data link provider, sending to the data link user a first response comprising an indication that the medium access control type is unknown to the interface;
at the data link user, issuing a second request to the data link provider to identify a communication protocol supported by the data link provider for the medium access control type; and
at the data link provider, sending to the data link user a second response enabling the data link user to parse the communication protocol.

20. A system for adapting a data link user for a communication protocol supported by data link user, comprising:
a data link provider configured to provide data link layer services;
a data link user configured to access said data link services; and
an extended implementation of DLPI (Data Link Provider Interface), in which:
said data link user is configured to request said data link provider identify a communication protocol supported by the data link provider; and
said data link provider is configured to offer said data link user, in response to said request, information for parsing the communication protocol.

21. The system of claim 20, wherein said data link provider comprises a device driver for a communication interface device.

22. The system of claim 20, wherein said data link user comprises a snoop utility for parsing a communication received by said data link provider.

23. The system of claim 20, wherein said information offered by said data link provider comprises an XML (Extensible Markup Language) document describing a format of the communication protocol.

24. The system of claim 20, wherein said information offered by said data link provider comprises a set of data describing a format of the communication protocol.

25. The system of claim 20, wherein said information offered by said data link provider comprises a set of processor executable instructions for parsing the communication protocol.

26. The system of claim 20, wherein said information offered by said data link provider enables said data link user to access, on said data link provider, a set of processor executable instructions for parsing the communication protocol.
